(19) United States
(12) Patent Application Publication
(10) Pub. No.: US 2010/0246314 A1
(43) Pub. Date: Sep. 30, 2010

(54) Truck Mixer

(75) Inventor: Berthold Ruf, Schoneburg (DE)

Correspondence Address: DILWORTH & BARRESE, LLP, 1000 WOODBURY ROAD, SUITE 405, WOODBURY, NY, 11797, US

(73) Assignee: LIEBHERR-MISCHTECHNIK GMBH, Bad Schussenried (DE)

(21) Appl. No.: 12/731,312

(22) Filed: Mar. 25, 2010

(30) Foreign Application Priority Data
Mar. 25, 2009 (DE) UM202009004188.3

(51) Int. Cl. B28C 5/20

(52) U.S. Cl. 366/63

(57) ABSTRACT

The present invention relates to a truck mixer with a mixing drum mounted and rotatable on a vehicle chassis, wherein a bearing of the mixing drum consists of a bearing pair comprising a race and at least one castor, wherein race and castor are not movable with respect to each other in axial direction.

### BACKGROUND OF THE INVENTION

The present invention relates to a truck mixer with a mixing drum mounted and rotatable on a vehicle chassis, wherein a bearing of the mixing drum consists of a bearing pair comprising a race and at least one castor.

In known concrete mixing trucks, the rear part of the mixing drum is freely supported on two rollers. In this way, a compensation for otherwise occurring tensions or deformations e.g. by torsions of the chassis in driving operation can be created by possible relative movements in axial direction.

The free support prevents that tensions are produced in the drum bearing due to movements or deformations in the chassis.

Due to these relative movements in axial direction, the roller must be significantly wider than the race, in order to ensure the safe support in all driving conditions. In all attachment parts in the rear region of the drum, clearances must also be taken into account for these movements. However, the utilization of the installation space available thereby is restricted. For example, the accommodation of filling and/or draining parts is limited.

Since the angular position between race and roller can change as a result of said deformations, either the roller or the race is constructed with a crowned surface, so as to always ensure sufficient support in rolling contact.

Such pairing of roller bearings, however, is not optimal, since rolling also is effected in axial direction. Furthermore, such pairing of roller bearings places high demands on material and construction.

### SUMMARY OF THE INVENTION

Therefore, it is the object of the present invention to develop a truck mixer as mentioned above in an advantageous way, in particular to the effect that the same includes an improved bearing in the rear region.

In accordance with the invention, this object is solved by a truck mixer with the features herein. Accordingly, it is provided that a truck mixer includes a mixing drum mounted and rotatable on a vehicle chassis, wherein a bearing of the mixing drum consists of a bearing pair comprising a race and at least one castor. Furthermore, it is provided that race and castor are not movable with respect to each other in axial direction.

This provides the advantage that an improved pairing of rolling elements becomes possible. The friction losses can be reduced and a generally improved mounting of the mixing drum becomes possible. Now, a sufficient support in rolling contact is ensured at any time.

Furthermore, it is possible that the bearing pair is part of the rear bearing of the mixing drum. This involves the advantage that bearing and drum outlet no longer can move relative to each other. This in turn provides for a reduction of the clearances for filling and draining parts, whereby an improvement of the properties of the filling and draining parts is obtained.

Furthermore, a part of the bearing pair can at least partly be movable in axial direction. In addition, it can be provided that the at least one castor is arranged in a frame and that castor and frame form a common bearing unit.

In the case of a plurality of castors, the castors can also be arranged in a common frame as bearing unit.

Advantageously, the frame can be connected with the chassis via movable props. Relative movements in axial direction between rear bearing and chassis hence advantageously are possible, so that a load compensation can take place. Supporting the bearing by means of movable props furthermore can provide the advantage that one bearing point each per chassis frame side is sufficient. This results in a considerable gain in installation space below the mixing drum, which can be utilized for accommodating components of the truck mixer system.

Preferably, the frame is fixed in axial direction relative to the race by means of at least one fixing means.

Furthermore, it is possible that the fixing means comprises a thrust washer, a roller and/or a race-roller form and/or is formed by the same.

In addition, it can be provided that the articulation of the bearing unit comprising castor and frame is arranged at a higher level than the support of the race on the castor. As a result, the bearing unit can always be maintained in the correct position due to gravity and an optimum rolling contact between rollers and race can be ensured.

Furthermore, the articulation of the bearing unit comprising castor and frame can be configured in pendulum fashion. In particular, it is advantageous when the articulation of the bearing unit to the props is located at a higher level than the support of the race on the rollers and at the same time is configured in pendulum fashion. This provides the advantage that the individual parts for this bearing are much lighter in weight and can be configured with less installation space than the structural parts like drum bearing blocks as they are used today. Advantages are obtained for example in terms of weight, transport and handling of the individual parts. Furthermore, weight and costs of the truck mixer can be reduced.

Advantageously, the components of the bearing are releasably connected with each other. As a result, a replacement in the case of a defect is easily possible. The so far higher maintenance costs as a result of the welded connections of the components of the rear bearing can now be avoided.

Particularly advantageously, the truck mixer is configured such that in the rear region below the mixing drum a water tank is arranged. Due to the rear bearing in accordance with the invention, a considerable gain in installation space can be obtained for example in the rear region below the mixing drum. This gain in installation space can be utilized e.g. for the installation of the water tank of the water system, possibly even of the entire water system of the truck mixer. As a result, the center of gravity of the entire vehicle is lowered. At the same time, installation space overlaps between water tank and exhaust gas system of the carrier vehicle can be avoided.

### BRIEF DESCRIPTION OF THE DRAWINGS

Further details and advantages will be explained in detail below with reference to an embodiment illustrated in the drawing, in which:

FIG. 1: shows a schematic view of a truck mixer, and

FIG. 2: shows a sectional representation A-A of the rear bearing of the mixing drum of the truck mixer shown in FIG. 1.

### DESCRIPTION OF THE PREFERRED EMBODIMENTS

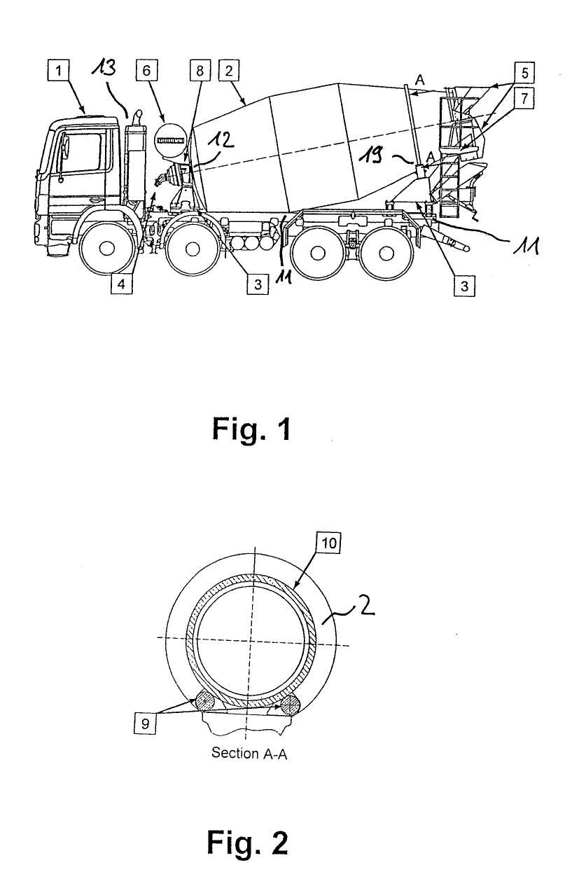

FIG. 1 shows a truck mixer 1 known per se, which includes a rotatable mixing drum 2 mounted on a truck with a built-in spiral not shown in detail. By rotating the drum 2 in one direction, charge can be drawn in and thoroughly mixed, and by rotating in the opposite direction, the charge can be conveyed out.

Beside the mixing drum 2, the main components of the truck mixer body are the supporting structure 3 of the rear bearing 19 of the mixing drum 2, the rotary drive 4 of the mixing drum 2, chutes and funnels 5 for charging and discharging, and a water system 6 and a ladder 7 e.g. for cleaning the body. The supporting structure 3 is mounted on the rear of the chassis 11 of the truck mixer 1. A comparable supporting structure 3 is also provided for attachment of the front bearing of the mixing drum 2 with the chassis 11.

At its front end, the drum base 12, the mixing drum 2 is attached to a rotatable flange of a transmission 8, in order to transmit the power of the drive components, in particular of the rotary drive 4, to the mixing drum 2. The flange of the transmission 8 is mounted in pendulum fashion, in order to compensate movements of the mixing drum 2 by deformations in the chassis 11 of the truck. Such deformations can occur in particular in driving operation, for example during use of the truck mixer 1 as concrete mixer on its way from the concrete factory to the site of use. On this way, the material to be mixed, here concrete, must be intermixed continuously, in order to prevent a solidification and hardening of the material to be mixed.

To provide for relative movements in axial direction of the vehicle in the backward, rear region of the mixing drum 2, the mixing drum 2 is freely supported on two castors 9. To prevent the mixing drum 2 from being deformed under dead load due to the weight at the support or the rear bearing, a race 10 is firmly welded to the mixing drum 2. In this way, the mixing drum is reinforced in the bearing region, so that a deformation under dead load cannot occur.

FIG. 2 shows the section A-A as it is indicated in FIG. 1. The race 10 stands on the castors 9, so that in the case of a rotation of the mixing drum 2 race 10 and rollers 9 roll on each other.

In accordance with the invention, it now is provided that the race 10 and the castors 9 are not movable with respect to each other in axial direction. In the preferred embodiment of the invention this means in detail that two castors 9, on which the race 10 stands and rolls in rotary operation, are mounted in a common frame, which no longer is firmly connected with the supporting structure or the chassis frame 11 of the truck mixer 1. Rather, this frame supporting the two castors 9 is connected with the chassis frame 11 of the truck mixer 1 via movably mounted props.

In axial direction, the bearing unit comprising the supporting structure and the castors 9 is fixed in its position in axial direction relative to the race 10 by compensating means 10. These compensating means can for example be a thrust washer, rollers or a race-roller form. The articulation of the bearing unit comprising the supporting structure and the castors 9 to the props is located at a higher level than the support of the race 10 on the castors 9 and is configured in pendulum fashion. As a result, the bearing unit always is maintained in the correct position due to gravity and an optimum rolling contact between rollers 9 and race 10 is obtained.

Since the rear bearing is supported on movably mounted props, one bearing point per chassis frame side is sufficient, whereby a considerable gain in installation space is obtained below the mixing drum 2. Due to the movably mounted props, no tensions are introduced into the chassis frame and the necessary relative movements are made possible in axial direction.

Since the positions of the bearing and of the drum outlet no longer can move relative to each other, the clearances for filling and/or draining parts are reduced in the embodiment of the truck mixer 1 of the invention as described here.

In a particularly advantageous embodiment, the gain in installation space below the mixing drum 2 is utilized for the installation of a water tank 6, whereby the center of gravity of the entire vehicle 1 is lowered. Thus, installation space overlaps between water tank 6 and exhaust gas system 13 likewise are avoided.

Since all parts of the rear bearing are screwed, a replacement in the case of a defect is easily possible.

1. A truck mixer (1) with a mixing drum (2) mounted and rotatable on a vehicle chassis (11), wherein
a bearing (19) of the mixing drum (2) includes a bearing pair comprising a race (10) and at least one castor (9), and the race (10) and castor (9) are not movable with respect to each other in axial direction.

2. The truck mixer (1) according to claim 1, wherein the bearing pair is part of the rear bearing (19) of the mixing drum (2).

3. The truck mixer (1) according to claim 1, wherein a part of the bearing pair is at least partly movable in axial direction.

4. The truck mixer (1) according to claim 1, wherein the at least one castor (9) is arranged in a frame and that castor (9) and frame form a common bearing unit.

5. The truck mixer (1) according to claim 1, wherein in the case of a plurality of castors (9) the castors (9) are arranged in a common frame as bearing unit.

6. The truck mixer (1) according to claim 4, wherein the frame is connected with the chassis (11) via movable props.

7. The truck mixer (1) according to claim 4, wherein the frame is fixed in axial direction relative to the race (10) by at least one fixing means.

8. The truck mixer (1) according to claim 7, wherein the fixing means comprises a thrust washer, a roller and/or a race-roller form and/or is formed by the same.

9. The truck mixer (1) according to claim 5, wherein the articulation of the bearing unit comprising castor (9) and frame is arranged at a higher level than the support of the race (10) on the castor (9).

10. The truck mixer (1) according to claim 5, wherein the articulation of the bearing unit comprising castor (9) and frame is configured in pendulum fashion.

11. The truck mixer (1) according to claim 1, wherein the components of the bearing are releasably connected with each other.

12. The truck mixer (1) according to claim 1, wherein in the rear region below the mixing drum (2) a water tank (6) is arranged.

13. The truck mixer (1) according to claim 2, wherein a part of the bearing pair is at least partly movable in axial direction.

14. The truck mixer (1) according to claim 13, wherein the at least one castor (9) is arranged in a frame and that castor (9) and frame form a common bearing unit.

15. The truck mixer (1) according to claim 3, wherein the at least one castor (9) is arranged in a frame and that castor (9) and frame form a common bearing unit.

16. The truck mixer (1) according to claim 2, wherein the at least one castor (9) is arranged in a frame and that castor (9) and frame form a common bearing unit.

17. The truck mixer (1) according to claim 16, wherein in the case of a plurality of castors (9) the castors (9) are arranged in a common frame as bearing unit.

18. The truck mixer (1) according to claim 15, wherein in the case of a plurality of castors (9) the castors (9) are arranged in a common frame as bearing unit.

19. The truck mixer (1) according to claim 14, wherein in the case of a plurality of castors (9) the castors (9) are arranged in a common frame as bearing unit.

20. The truck mixer (1) according to claim 13, wherein in the case of a plurality of castors (9) the castors (9) are arranged in a common frame as bearing unit.
